(19) United States
(12) Patent Application Publication
(10) Pub. No.: US 2011/0087709 A1
(43) Pub. Date: Apr. 14, 2011

(54) METHODS AND SYSTEM FOR DYNAMIC DATABASE CONTENT PERSISTENCE AND INFORMATION MANAGEMENT

(76) Inventor: Ramani Sriram, Fremont, CA (US)

(21) Appl. No.: 12/577,650

(22) Filed: Oct. 12, 2009

(51) Int. Cl. G06F 17/30; G06N 5/02

(52) U.S. Cl. 707/803; 719/328; 706/46; 707/E17.045; 707/E17.046; 707/E17.125

(57) ABSTRACT

According to one embodiment of the invention, a method for composing information into a generic information cell structure, which includes an information vacuole and a cell, is provided. In another embodiment, attaching generic tags, which correspond to the generic information cell structure, is provided. In another embodiment, generating structural and positional identification, fetching information characteristics, decomposing an information element into an atom class, processing the information element, and forming a native data manipulation statement, is provided. In another embodiment, a data repository, which includes an information element name and an atom type is provided. In yet another embodiment, a data directory, which includes a cell structure storage location identification, is provided. In one embodiment, a method of routing data by receiving a data store location identification for information, is provided. The data store identification may be externally defined and/or run-time defined. In another embodiment, a method for detecting an interaction within a transaction, where the transaction spans one or more sessions, storing intermediate transactional data, and providing a state description for the intermediate transactional data, is provided.

This patent application claims priority to United States Patent Application “Methods and System for Dynamic Database Content Persistence and Information Management”, to Ramani Sriram, filed Nov. 12, 2004 and assigned application Ser. No. 10/988,002 and to United States Provisional Patent Application entitled “Method And Architecture For Flexible And Dynamic Database Content Persistence And Information Management,” to Ramani Sriram, filed on Nov. 13, 2003 and assigned Application No. 60/520,360, hereby incorporated by reference herein.

### TECHNICAL FIELD

The field relates to data storage and processing, and, more particularly, to methods and system for dynamic database content persistence and information management.

### BACKGROUND

Traditional persistence mechanisms and information network architectures map information content, structure, and relationships into database tables. Database systems manage formatted collections of shared data.

A prevalent type of database today is a relational database. A relational database is a collection of data items organized as a set of formally-described tables from which data can be accessed in many different ways without having to reorganize the database tables. A relational database stores data in two-dimensional tables. Each table (also referred to as a relation) contains one or more categories of data organized in columns. The names of the columns of the table are referred to as data fields, which are the finest granularity of data units available for users to manipulate. A data field is a basic data type such as name, age, address, etc. A row or record of a table contains a unique instance of data for the categories defined by the columns. Each row has one component for each data field of the table. One or more indexes on large tables are generally provided to facilitate data accesses. A typical software application may be made up of a proliferation of tables, rows, columns, and objects, with attributes and relations.

Although the rows of a table are frequently modified, schema changes, while possible in commercial database systems, are very expensive and inefficient because each one of the perhaps millions of rows may need to be rewritten to add or delete components. If a data field is added, for example, it may be difficult or even impossible to find the correct value for the new component of the rows. When columns are added to, deleted from, or modified within a table, metadata change is necessary. Accordingly, modeling data structures, relationships, and key constraints, designing and creating database tables, maintaining referential integrity, data consistency, and the privilege model, tuning for performance and archiving, operating and maintaining a database is highly complex, cumbersome and time-consuming. Moreover, the proliferation of tables and foreign key relationships necessitates elaborate and expensive operational tasks for back-ups, archival, error recovery, replication and management.

Furthermore, typical software applications are often database-dependent, meaning applications are adapted to a particular backend data store or metadata design. However, this rigidity effectively limits the application from operating on different types of data stores absent significant remodel, redesign, and change to application software.

Generally, external data routing capability is not provided for distributed storage solutions. Partitioning can increase the speed and efficiency of data access. A table can be divided into partitions, with each partition containing a portion of the table's data. A partition containing more frequently used data can be placed on faster data storage devices. However, the data routing capability is restrictive in purpose and scope. In addition, data may not be easily distributed to different data store types or in different data store instances. Thus, designing and creating database tables, maintaining referential integrity, data consistency, and the privilege model, tuning for performance and archiving, and operating and maintaining a database is highly complex, cumbersome and time-consuming.

In the prior art, one Extensible Markup Language (XML) structure is tailored for one type of information. Particularized XML tags are information-specific by corresponding to particular data elements. For example, an XML schema for a purchase order includes particularized tags for purchase order data elements. However, the prior art XML structure and accompanying tags are highly dependent on information type, are not generalized to be information type-independent, and require time and effort to maintain for different types of information. Due to a lack of standardization, transformation from one particularized structure to another is cumbersome to implement.

Templates for particular information are also limited by their rigidity. For example, in the case of relational databases, metadata is embedded in information-specific tables. Accordingly, templates are “hard-coded” in the information-specific business logic and persistence. Thus, the prior art templates cannot be reused or generalized to apply to different types of information or information without structure or with evolving structure. Moreover, metadata requires time and effort to maintain for different types of information.

A data dictionary is generally a table that holds metadata. The typical data dictionary holds information such as a list of all the tables in the database, the structure of the tables, and general database structure. However, a data dictionary fails to enable consistency in semantic, usage, and interpretation of information.

Typical relational database management systems have restrictive transactional capability. A transaction is a unit of work consisting of one or more individual steps and/or operations to be applied to one or more local and/or remote databases as a single unit of work. A characteristic of transactions is the requirement that either all steps and/or operations are applied or all are rolled back in the case of a problem so that the database is always left in a consistent state.

Transactions involving a single database, typically involve the following operations which are all handled as part of the standard operations of the database management systems (DBMS):

1. Begin: Beginning a transaction creates a transaction scope. From the time the transaction is begun until it is successfully committed or rolled back, operations against the database will be within the scope of the transaction and will either all succeed or all fail.

2. Commit: Committing a transaction tells the database that all processing has completed satisfactorily, and that the results should be written to persistent storage. Before a commit is issued, changes may be undone by issuing a “rollback” command. If there is a system crash prior to a commit, on recovery the database will revert to the state it was in before the transaction was begun. Executing the commit ends the transaction.

3. Rollback: Rolling back a transaction revokes any changes that occurred during the transaction, leaving the database in the state in which it was found prior to the transaction. After a transaction is committed, it can no longer be rolled back.

Two-phase commit is a well-known technique to synchronize multiple resources in transaction processing systems. The two-phase commit protocol has two phases that are typically referred to as “Prepare” and “Commit.” In the Prepare stage, all resource managers participating in the transaction are told by a transaction manager to prepare to commit their changes. The databases are instructed to perform all processing steps short of writing the updates to persistent storage. After each database completes the “Prepare” phase, it sends a reply to the transaction manager indicating success (vote commit) or failure (vote rollback). After a database votes commit (indicating success), it may not initiate a rollback and may only implement a rollback if instructed to do so by the transaction manager.

If the Prepare stage has completed satisfactorily (i.e., if all databases voted commit), the transaction manager enters the Commit phase. In this phase, the transaction manager instructs each of the participating databases to commit their changes. After completion, each database reports to the transaction manager that it has completed the transaction. When all databases report completion, the transaction is completed. The two-phase commit protocol is described in more detail in the Open Group Technical standard titled “Distributed TP: The XA Specification,” C193, ISBN 1-872630-24-3, February, 1992, and in the Open Group Guide titled “Distributed TP: Reference Model, Version 3,” G504, ISBN 1-85912-170-5, February 1996.

The transaction manager collects the replies from all the involved databases. A single vote rollback results in the rollback of the entire transaction. If the transaction manager receives no response from one of the participants, it assumes the operation has failed and rolls back or aborts the transactional unit. The transaction manager rolls back the transaction by sending a rollback instruction to all participating databases. All “dirty stores” are subsequently erased. Accordingly, the prior art is limited in that a data store does not retain all data, including data for which the transaction was rolled back.

Deadlock is a condition that occurs when two processes are each waiting for the other to complete before proceeding. The result is that both processes hang. Deadlocks occur most commonly in client/server and web-based environments. When a transaction fails to complete in a finite and usually small amount of time, a deadlock may occur, resulting in performance degradation. Thus, the prior art cannot support long-standing transactions.

Moreover, a transaction exists only in the context of a user session. Therefore, a transactional unit cannot be shared across collaborating individuals or processes. Additionally, transaction management is typically only available for information stored in a relational database.

### BRIEF DESCRIPTION OF THE DRAWINGS

In the drawings, like reference numerals refer to like parts throughout the various views of the non-limiting and non-exhaustive embodiments of the present invention, and wherein:

FIG. 1 is a high-level block diagram illustrating the relationship between one embodiment of an information management system and existing systems;

FIG. 2 is a flow diagram of one embodiment of a process for receiving information;

FIG. 3 is a flow diagram of one embodiment of a process for the decomposition in one embodiment;

FIG. 4 is a flow diagram of one embodiment of a process for the formation of a native data manipulation statement in one embodiment;

FIG. 5 is a flow diagram of one embodiment of a process for result composition;

FIG. 6 is a block diagram illustrating one embodiment of a generic information cell structure;

FIG. 7 is a block diagram illustrating one embodiment of a generic XML structure;

FIG. 8 is a block diagram illustrating one embodiment of a data thesaurus;

FIG. 9 is a block diagram illustrating a one embodiment of a transactional unit; and

FIG. 10 is a block diagram of an exemplary computer system that may perform one or more of the operations described herein.

### DETAILED DESCRIPTION

In the following description, numerous details are set forth. It will be apparent, however, to one skilled in the art, that the present invention may be practiced without these specific details. In other instances, well-known structures and devices are shown in block diagram form, rather than in detail, in order to avoid obscuring the present invention.

Reference throughout this specification to “one embodiment” or “an embodiment” means that a particular feature, structure, or characteristic described in connection with the embodiment is included in at least one embodiment of the present invention. Thus, the appearance of the phrases “in one embodiment” or “in an embodiment” in various places throughout this specification are not necessarily all referring to the same embodiment. Furthermore, the particular features, structures, or characteristics may be combined in any suitable manner in one or more embodiments.

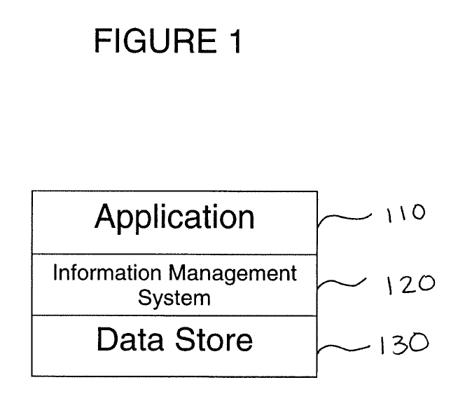

FIG. 1 is a high-level block diagram illustrating the relationship between one embodiment of an information management system and existing systems.

The information management system 120 may reside between an application 110 and a backend data store 130. In another embodiment, the information management system 120 resides between multiple applications and multiple data stores. In yet another embodiment, the information management system 120 resides in an application 110 or data store 130.

In one embodiment, a data store may include a relational database, object oriented database, text file, ASCII file, or the like, including, for example, Oracle, Sybase, DB2, SQL Server, Veritas File System, or the like.

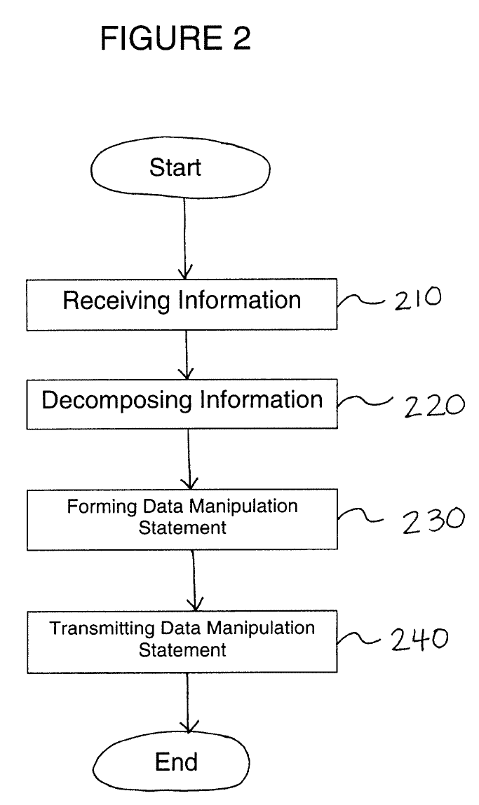

FIG. 2 is a flow diagram of one embodiment of a process for receiving information. The process is performed by a processing logic that may comprise hardware (e.g., circuitry, dedicated logic, etc.), software (such as is run on a general purpose computer system or a dedicated machine), or a combination of both.

In one embodiment, the application interacts with the application program interfaces (API) of the information management system. In processing block 210, the information management system receives stylized information and operation information. In one embodiment, the stylized information is aligned to a generic information cell structure and is composed in a generic XML structure. Alternatively, the stylized information is composed in a generic Object structure. In one embodiment, the operations may include add, change, delete and fetch operations. In another embodiment, the operation information is embedded in the generic XML structure. In yet another embodiment, the information management system provides for generic processing of information without a priori knowledge of semantic meaning, structure, or intra and inter-information relationships.

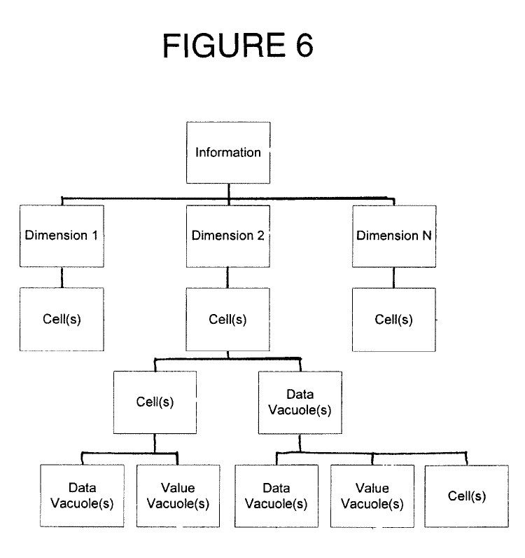

Referring to the block diagram of FIG. 6, one embodiment of a generic information cell structure is illustrated. The information is stripped of its semantic meaning with the use of the information cell structure.

Multiple and diverse types of information may be represented by the generic information cell structure. For example, the information may include a business transaction, such as a purchase order, business information such as parts master data, a complex document with sections, chapters, sub chapter, paragraph groups, paragraphs, and the like. The information may include the content of e-mail, movies, pictures, music, drawings, software applications, or any other information type.

At the highest level in the cell structure, an information vacuole is a construct that represents an instance of information. The stylized information may also be structured into one or more data elements and/or dimensions of cells. Examples of a data element may include a dimension name, data element name, creation date time stamp, a deletion date time stamp, an information owner unique identification (UID), status, operation, cell creation date time stamp, cell deletion data time stamp, state, cell UID, type, version number, session user, session service, qualifiers, such as qualifier language, qualifier unit of measurement (UOM), qualifier currency, and qualifier date format, transaction handle, transaction is first in, transaction start date time, sequence number, and the like.

In one embodiment, data elements in the information correspond to the atoms of the cell. In one embodiment, an atom defines a unique set of behavior associated with a fundamental element of data and information management processes in the information management system. In one embodiment, an atom encapsulates the information element at the smallest level of granularity. In one embodiment, an atom may correspond to a column or data field in a database table. Atoms have common characteristics and information management processing logic. For example, atom type descriptors may include an Entity atom, Amount atom, Text atom, Quantity atom, Rate atom, Date atom, File atom, Audio atom, Video atom, and the like.

In one embodiment, an Entity atom may represent data elements for which an identity has been pre-described. An Amount atom may include a process to perform consistency checks of received values to ensure the received values are numbers. In another embodiment, an Amount atom includes a process to translate currency. Text atoms, may have a language implication. Text atoms managed by the information management system may have equivalent values in other languages. Quantity and Rate atoms have a unit of measure implication and associated UOM translation processing. In one embodiment, a Date atom includes a process to perform consistency checks to ensure valid date values are received. A Date atom may also include a process to toggle between date formats in a received form and a stored form. In another embodiment, a Date atom further includes processes to calculate a number of days, or a number of business days, between a first date and a target date, as well as other date-related processing. In one embodiment, a File atom includes a process to fetch a filename and path.

The stylized information may be further refined into multiple dimensions. In one embodiment, a dimension may distinguish data from metadata. For example, one dimension may represent content and another dimension may represent structure of the stylized information vacuole. Content information may include an information payload, such as a purchase order information, part information, a document, etc.

Structure information may include information characteristics, templates, information descriptors, cell descriptors, information key, cell key, content type, encryption rules, transactionality steps, access control restrictions, error conditions, exceptions, storage location identification for the information, and the like. In another embodiment, a dimension distinguishes between multiple types of metadata.

Metadata, such as data defining structure, may be previously defined using a toolset. Alternatively, the structure information represented by one or more dimensions is received by the information management system with each information instance, payload, or content. In one embodiment, a dimension is further defined by elements and/or one or more cells.

A cell may be comprised of Cell UID, and order information, such as Cell Sequence number, and the like. In one embodiment, a Cell UID uniquely identifies the cell in the context of the information vacuole instance to which it belongs. Each cell in a dimension has a Cell Sequence number and Parent Cell UID that provides the information with a location-based identity. In one embodiment, the location-based identity specifies where the cell and corresponding information occur within a parent cell or information structure. A cell may further be defined by other cells, data vacuoles, and value vacuoles. In one embodiment, a cell is composed of cells within the cell.

The data vacuole is a structure that identifies a data element. In another embodiment, the data vacuole includes a data element name and one or more values for the data element. A data vacuole may also include a sequence number to identify its location within the parent cell structure. In another embodiment, a data vacuole includes other structural and positional identification. In one example, information which may be represented by a data vacuole may include a purchase order number, a part number, a paragraph of a document, a frame of a video, and the like. In one embodiment, data vacuole elements include a data element name, data element sequence number, and the like. The data vacuole may be further composed of other data vacuoles, value vacuoles, or cells. Data vacuoles inside of a data vacuole provide a capability of having a hierarchical structure associate with information. In one embodiment, data storage management occurs at a data vacuole level.

A value vacuole sets the value of a data element. In another embodiment, the value vacuole permits a data element to hold multiple values. Accordingly, a value vacuole may also specify a sequence number. The value vacuole may also be a qualifier. There are different qualifiers for different types of data elements. For rates or monetary amounts, the qualifier is currency. For quantity, the qualifier is a unit of measure. For text, the qualifier is language. For date, the qualifier is the date format. A value vacuole may be defined by value vacuole elements, such as a value, value sequence number, value qualifier, and the like.

In another embodiment, a value vacuole sets the value of a parameter, qualification, or identification for a construct in the cell structure. In one embodiment, a value vacuole under this construct is composed within a cell vacuole. In one embodiment, a value vacuole that is not a part of a name-value pairing may not be persisted.

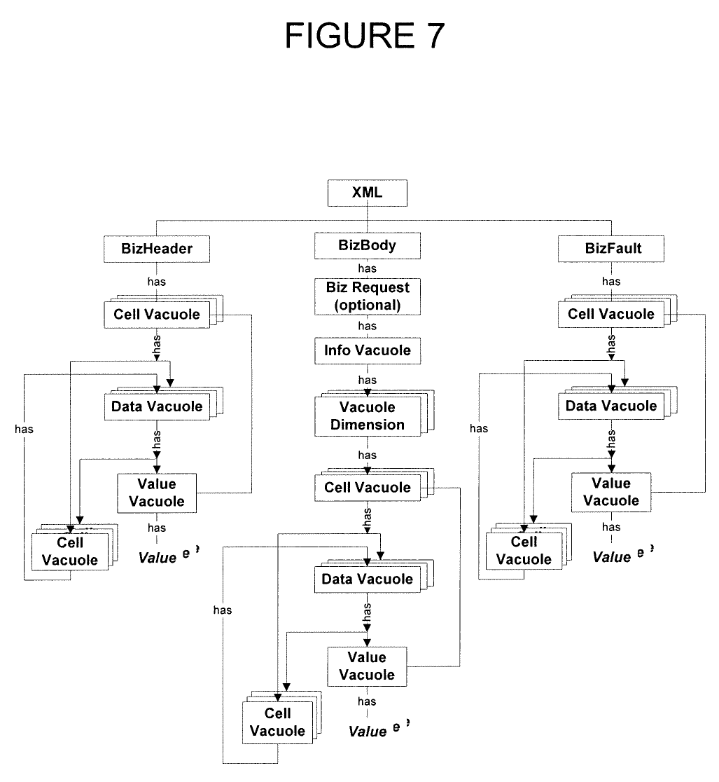

Referring to the block diagram of FIG. 7, one embodiment of a generic XML structure is illustrated. The generic XML schema includes a set of generic tags, which may be used for any information, including information structure, document structure, software system structure, and the like. Reference to the XML generic tags, as used herein, may include tags and/or attributes. In one embodiment, the XML tags and/or attributes do not carry any information-specific meaning. Rather, the information-specific elements, the name-value pairing of the element, are values within the tags and/or attributes in the XML.

Informational content may range from simple to complex information types, including business content (e.g., Purchase Order, Invoice, Employee Expense Report, Parts Master information, Inventory, Bill of Material, Production Master Plan, etc.), a newspaper in electronic format, a novel or a book in electronic format, a document, a movie in digital format, music in electronic format, photographs in electronic format, or other forms of information.

In one embodiment, the generic tags and/or attributes carry pre-defined structural and positional attributes. In one embodiment, the generic tags and/or attributes mirror the generic information cell structure described in FIG. 6. In one embodiment, generic structural tags and/or attributes identify, characterize, or describe in a non-information-specific manner, dimensions, cells, data vacuoles, value vacuoles, version number, information owner, information type, information UID, cell UID, cell sequence number, data element name, data element sequence number, data element value, value vacuole sequence number, state descriptions, and the like.

In another embodiment, the stylized information is composed in a generic Object structure. In one embodiment, the generic Object structure includes operation information including the operation name and user-defined parameters for the operation.

In one embodiment, a toolset receives information in a format and returns data in the same format. For example, the toolset may receive information in any structure, such as an input stream, a string buffer, or the like. Moreover, information may be received from any text fie, flat file, comma-delimited file, such as comma-separated values (CSV) file, relational database that implements Java Database Connectivity (JDBC) mode for data manipulation, any other type of data storage which is accessible via JDBC or which exposes published APIs for data manipulation, or the like. The toolset may translate the information into the generic XML structure or the generic Object structure.

In one embodiment, the toolset is external to the information management system 120. In an alternative embodiment, the toolset, in part or in whole, is bundled with the application 110. In yet another embodiment, the toolset, in part or in whole, is bundled with the data store 130.

Referring back to FIG. 2, in processing block 220, the system decomposes the stylized information into one or more atom groups. In processing block 230, a manipulation statement, which is native to the data store, is formed. In processing block 240, the native data manipulation statement is transmitted to the data store. In another embodiment, the system establishes a connection to the data store and invokes the data management operation in the data store. In one embodiment, information is stored in a database as a single table.

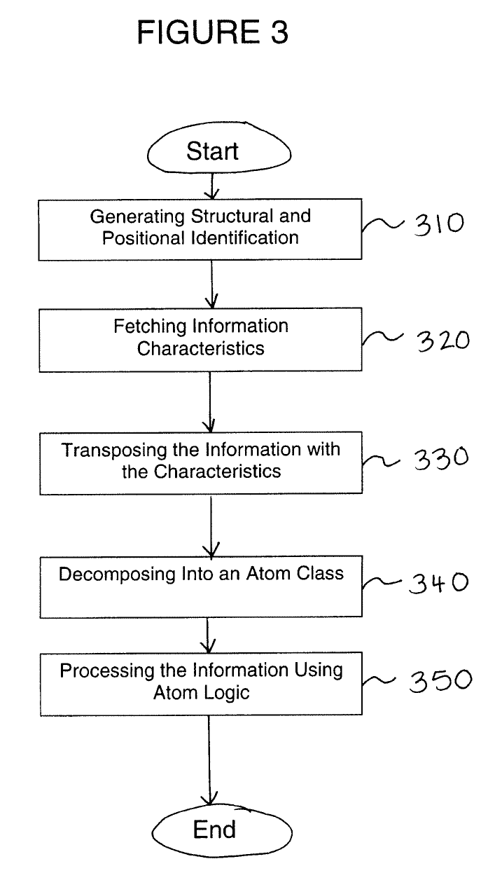

FIG. 3 is a flow diagram of one embodiment of a process for the decomposition in one embodiment. The process is performed by a processing logic that may comprise hardware (e.g., circuitry, dedicated logic, etc.), software (such as is run on a general purpose computer system or a dedicated machine), or a combination of both. The processes of FIG. 3 are in reference to processing block 220 of FIG. 2.

The decomposition process begins, in one embodiment, at processing block 310, where the information management system generates structural and positional identification for the received information. The identification allows the information management system to maintain the exact structure and positional integrity of the information. In one embodiment, the identification identifies one or more individual cell structure, the position and location in which the cell structures occur, and their positional relationship to other cell structures. In one embodiment, a cell structure includes an information vacuole, a dimension, a cell, a data vacuole, or a value vacuole.

In one embodiment, the structural and positional identification includes one or more of an information UID, and a version number. The information management system may generate an information UID, which uniquely identifies the instance of the information. The system may assign a version number to identify a version number of an information instance. In another embodiment, structural and positional identification includes an Info Type, which identifies the type of the information, and Info Owner, which identifies the owner of the information.

In another embodiment, the structural and positional identification includes one or more of a cell UID, cell sequence number, and parent cell structure UID. The information management system may generate a cell UID to uniquely identify the cell in the context of the information. The system may assign a cell sequence number to identify the position of the cell in the parent cell structure. The system may also identify the parent cell structure UID.

In one embodiment, structural and positional identification also refers to any other structure of the information cell structure. Accordingly, the Cell UID, Cell Seq Num, and cell unique identification may be generated for any dimension, cell, data vacuole, or value vacuole.

In processing blocks 320 and 330, the information management system associates metadata with the information. As previously discussed, metadata, such as data defining structure, may be previously defined. In one embodiment, the data defining structure is defined in a data definition repository or a data thesaurus. Alternatively, structural information, such as characteristics or templates, may be received with the information instance, payload, or content.

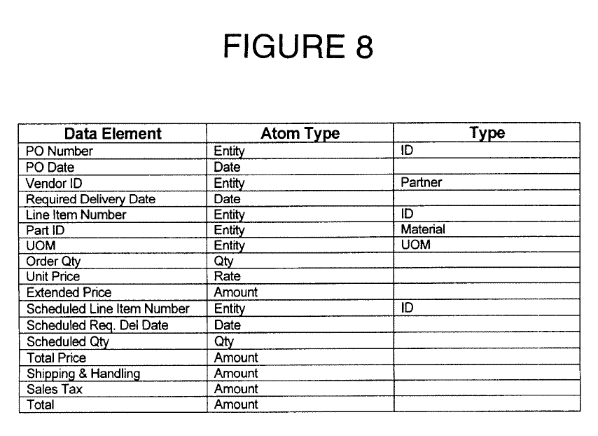

Referring to the block diagram of FIG. 8, one embodiment of a data thesaurus is illustrated. In one embodiment, the data thesaurus maintains descriptions of information elements, which are the smallest units of information. In one embodiment, the data thesaurus includes an information element name, information element type to describe the function of the element, synonyms, description, label names, usage information for where the information element is used, help information, characteristics, atom type, and the like. In one embodiment, label names are used to distinguish among purposes for the information element. For example, purposes may include for display on a screen, for reports, for description in a document, and the like. In another embodiment, the data thesaurus provides APIs for localization, in which the information element labels are maintained in a native language of a locality. In one embodiment, the data thesaurus allows public sharing of atoms.

As discussed in relation to FIG. 6, metadata, such as data defining structure, may be previously defined using a toolset. Accordingly, atom behavior may be pre-defined in a Data Thesaurus. For example, Part identification (ID) in a purchase order may be an Entity atom where an instance of the Part ID may be set-up before being used in the purchase order. Furthermore, an Amount atom may be predefined to ensure received values are in a proper format. A Date atom may be predefined to ensure the received values are valid date values. In another embodiment, the Data Thesaurus may include the processes of other predefined atoms.

Referring back to FIG. 3, in processing block 320, the information management system fetches the metadata from the data store or from a dimension in the stylized information. In one embodiment, the characteristics of an information are fetched. Characteristic information may identify atoms and atom parameters for each data vacuole in the stylized information.

In processing block 330, the stylized information is transposed with the corresponding characteristics information. In one embodiment, the information elements from the information are compared against the data thesaurus to ensure validity.

In processing block 340, the information management system decomposes the stylized information into atom groups. Each information element may be decomposed according to its atom class as defined by the characteristic information.

In processing block 350, the information management system processes an atom logic. Each atom may be based on different processing logic. In one embodiment, an information element defined as an Entity atom requires an integrity check to ensure the entity is consistent with other information in the data store. For example, in a purchase order, a vendor ID information element, classified as an Entity atom, may be checked to ensure the vendor exists in the data store.

In another embodiment, an information element defined as a File atom requires different processing. An information element defined as a File atom may require the system to fetch the filename and path from the data store and subsequently fetching the file using the path.

In one embodiment, the process of a Date atom includes date-related processing. Processing may include conversions between date formats, calculations between dates, and other date-related functions.

In another embodiment, the process of an Amount atom includes multi-currency transformations. In one embodiment, an entry is created in the transaction currency and the base currency and is stored in the data store. In another embodiment, an atom may provide processes for calculating realized gains and losses, unrealized gains and losses for mark to market posting, translation between transaction currency and base currency, and the like.

In yet another embodiment, the process of a Duration atom provides duration-dependent processing and translations. In one embodiment, the duration is measured by any unit of time. In another embodiment, the process of a Quantity atom includes unit of measurement related processing. In another embodiment, the process of a Rate atom includes unit of measurement processing.

In another embodiment, the process of a Text atom includes language-related localization and personalization. For example, a text may be translated into a local or personalized language prior to persistence and displayed to users.

In another embodiment, the process of a Text Area atom also includes language-related processing. In one embodiment, the text block is portioned and each portion is saved to the data store as a value. During a fetch operation, one or more lines comprising the text block are assembled and returned.

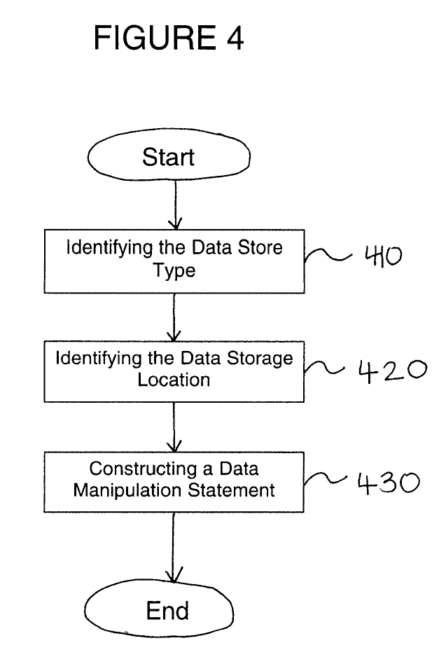

FIG. 4 is a flow diagram of one embodiment of a process for the formation of a native data manipulation statement in one embodiment. The process is performed by a processing logic that may comprise hardware (e.g., circuitry, dedicated logic, etc.), software (such as is run on a general purpose computer system or a dedicated machine), or a combination of both. The processes of FIG. 4 are in reference to processing block 240 of FIG. 2.

In processing block 410, the information management system identifies the data storage type. In one embodiment, the system identifies the data storage engine type with which to engage in communication. A data storage engine type may include a relational database, object oriented database, text file, ASCII file, or the like. In one embodiment, the system also identifies the data storage application, such as Oracle, Sybase, DB2, SQL Server, Veritas File System, or the like.

In processing block 420, the data storage location is identified. In one embodiment, the machine IP with which to communicate, the machine port number on which the storage engine listens, and the storage server instance name within the machine are identified.

In one embodiment, the storage location identity is stored in a data directory service. In one embodiment, the data directory provides a roadmap to distributed data stores. The data directory includes the information contained in each data store. In one embodiment, the location, data store type, and data store instance in which to store information is specified. In another embodiment, the information is specified at any level in the cell structure, from the Infoiniation Type to the data element.

In one embodiment, the data directory maintains location identities for information type, cells, and information elements. In one embodiment, the location identity includes a uniform resource location (URL). In one embodiment, the information requested may be located in more than one computer or device. For a fetch, change/modify, and delete operation, location identities from the data directory may be requested, and connections to each of the locations identified as containing the requested information may be established. A fetch or select operation may aggregate the return values from different data store locations into a single result. For change/modify or delete operations, the operation may be performed at each location.

For an insert operation, the location identity or identities where the data will be stored is determined, the data directory service may be updated with the location identity or identities of the data, and a connection to the location(s) may be established. A router directs the data to the appropriate locations and the insert operation may be performed at the location(s). In one embodiment, the location identity or identities where the data will be stored is previously defined in the data directory. In one embodiment, the location identity is defined externally from the DBMS. In one embodiment, external data routing includes a user, such as a database administrator, pre-defining a location identification. In another embodiment, location identities are provided as a dimension of the received information.

In another embodiment, the location identity is defined by the system at run-time through load balancing, availability checks, and data routing rules. In one embodiment, data is routed to different data store types on different physical machines in a distributed data store or in different data store instances. In one embodiment, different portions of information or different information types are routed and stored.

In processing block 430, a data manipulation statement is constructed for the storage engine type and information management operation. In one embodiment, a data store interface constructs a native data manipulation syntax from the stylized information.

In one embodiment, the storage location identification is embedded into the data manipulation statement. In one embodiment, the storage location identification specifies the location of a data for use in a distributed storage network, such as a Peer-to-Peer system. More specifically, the identification may include the machine IP, the machine port number on which the storage engine listens, and the storage server instance name within the machine. In one embodiment, storage location identification is pre-defined or provided as a dimension of the received information. In another embodiment, the storage location identification may be generated by the information management system in a storage load-balancing process or storage availability check process.

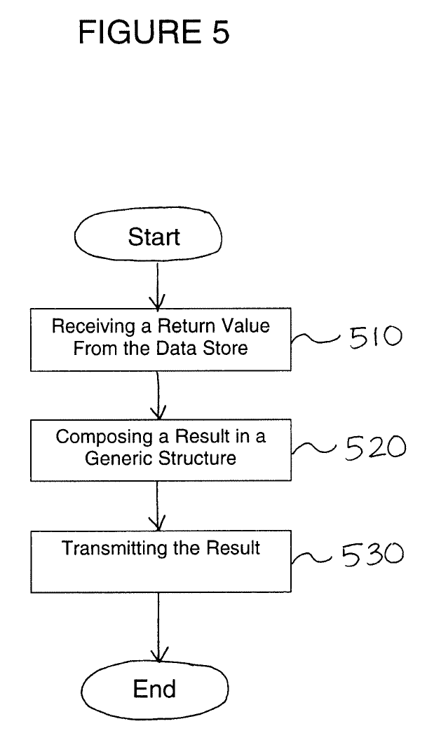

FIG. 5 is a flow diagram of one embodiment of a process for result composition. The process is performed by a processing logic that may comprise hardware (e.g., circuitry, dedicated logic, etc.), software (such as is run on a general purpose computer system or a dedicated machine), or a combination of both. In one embodiment, a result is returned to an application for an information management operation. In one embodiment, a result is composed for a fetch, search, select, or similar operation.

In processing block 510, the information management system receives a return value from a data store. In processing block 520, the system composes a result in a generic XML format or the generic Object structure from the received return value. In one embodiment, the cells are composed back into their original information structure based on the structural and positional identification, such as Cell unique identification (UID), Cell sequence number (Seq Num), Parent Cell UID, and the like. In one embodiment, the structural and positional identification enable the construction of the cell hierarchy of the original cell structure in the information. Moreover, the structural and positional identification may also place a cell in a location among other cells.

In processing block 530, the system may transmit the result. In one embodiment, the result is transmitted to an application initiating data store communication. In another embodiment, the result is transmitted to a toolset to translate the result from the generic XML format or the generic Object structure into an acceptable format for the application.

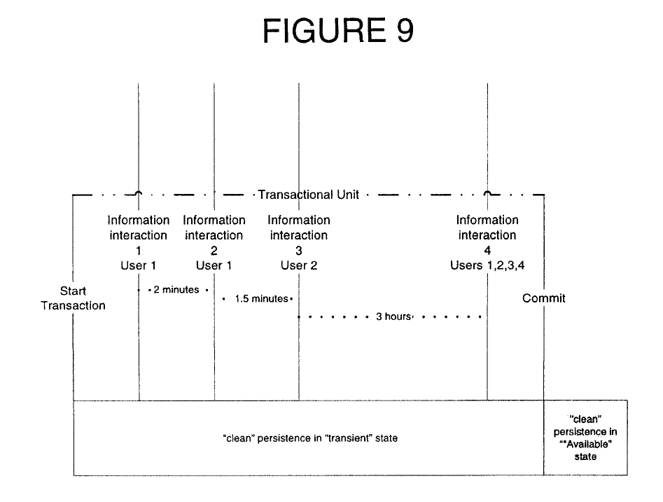

FIG. 9 is a block diagram illustrating a one embodiment of a transactional unit. In one embodiment, a transactional unit spans multiple interactions with one or more users or processes. In another embodiment, a transaction spans one or more sessions.

In one embodiment, state management provides transactionality for any type of data store. In one embodiment, the data store has a placeholder for state descriptions for any level of the cell structure. For example, state descriptions may be maintained at the information vacuole level and the Cell level. In another embodiment, transactionality is externalized from the DBMS.

State descriptions may include “Persisted” or “Committed,” “Transient,” “Error,” “Exception,” “Depreciated,” “Deleted,” “Rolled Back,” “Time Out,” “Archive,” and the like. In one embodiment, when all processing has been completed satisfactorily, the state manager may change the state description to “clean” or “committed.” In one embodiment, the state description is changed from “dirty” or “transient” to “committed.”

In one embodiment, transactional data from each interaction in a transaction is stored in a data store and is accompanied by a state description. The transactional data may be stored in a “Transient” state. In one embodiment, when a transaction is committed, information, information cells and corresponding elements are transitioned to the “Persisted” state. In one embodiment, the occurrence of an exception during the transaction results in a state transition to “Exception.” In one embodiment, if a transition is rolled back, the state transitions to a “Rolled Back” state. Thus, a transaction may span one or more user sessions. In one embodiment, start a transaction, interactions within the transaction, commit the transaction, abort the transaction, and the like, may occur in one or more sessions. In another embodiment, the intervals between sessions are not bounded by time limitations. Accordingly, in one embodiment, a transaction is shared between multiple users or processes.

In one embodiment, transactional data, including intermediate data, are retained. Thus, for example, in the case a transaction is rolled back, the intermediate data is retained, leaving an audit trail. By retaining the intermediate data, in another embodiment, the erroneous data may be corrected and the transaction may be completed without having to restart the entire transaction. Accordingly, intermediate data within a transaction may be maintained to support long-standing transactions. In another embodiment, the information management system manages transactions in a distributed data store for diverse data store types in a single transaction.

In another embodiment, the state descriptions are applied to a higher level of information to manage transactionality. In one embodiment, constructs to begin, commit, and roll back transactions, and to link to another transaction is provided. In another embodiment, the storage management processes manage distributed data storage, real-time data replication capability, storage load balancing, data routing to storage located on a LAN, WAN, and the world-wide-web. The storage management processes may also handle archival and ensure high availability through real-time redundant data storage. In one embodiment, transaction management is externalized from a DBMS.

Elements of the invention may be embodied in hardware and/or software as a computer program code. The processes described above can be stored in the memory of a computer system as a set of instructions to be executed. In addition, the instructions to perform the processes described above could alternatively be stored on other forms of machine-readable media, including magnetic and optical disks. For example, the processes described could be stored on machine-readable media, such as magnetic disks or optical disks, which are accessible via a disk drive (or computer-readable medium drive). Further, the instructions can be downloaded into a computing device over a data network in a form of compiled and linked version.

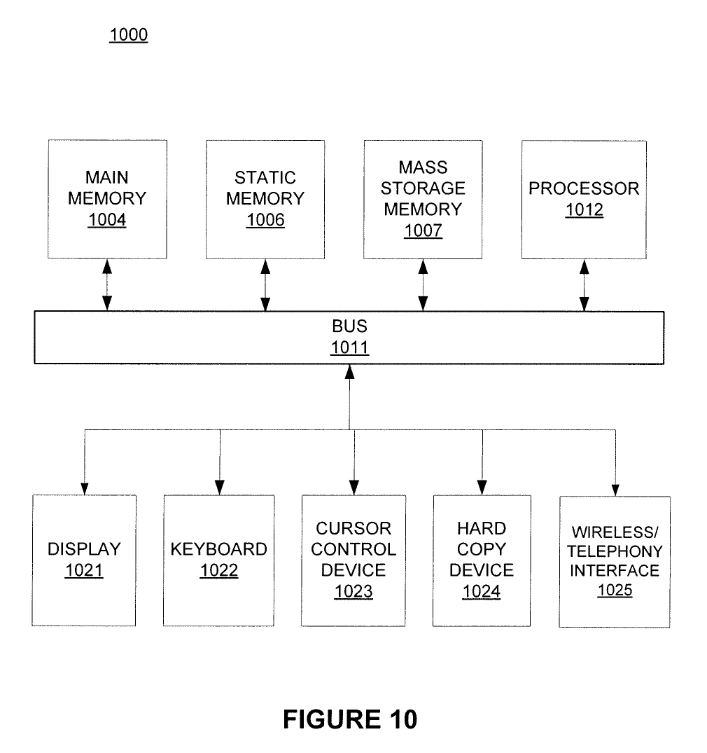

FIG. 10 is a block diagram of an exemplary computer system that may perform one or more of the operations described herein. The computer system 1000 may comprise an exemplary client or server computer system. Computer system 1000 comprises a communication mechanism or bus 1011 for communicating information, and a processor 1012 coupled with bus 1011 for processing information. Processor 1012 includes a microprocessor, but is not limited to a microprocessor, such as, for example, Pentium™, PowerPC™, Alpha™, etc.

System 1000 further comprises a random access memory (RAM), or other dynamic storage device 1004 (referred to as main memory) coupled to bus 1011 for storing information and instructions to be executed by processor 1012. Main memory 1004 also may be used for storing temporary variables or other intermediate information during execution of instructions by processor 1012.

Computer system 1000 also comprises a read only memory (ROM) and/or other static storage device 1006 coupled to bus 1011 for storing static information and instructions for processor 1012, and a data storage device 1007, such as a magnetic disk or optical disk and its corresponding disk drive. Data storage device 1007 is coupled to bus 1011 for storing information and instructions.

Computer system 1000 may further be coupled to a display device 1021, such as a cathode ray tube (CRT) or liquid crystal display (LCD), coupled to bus 1011 for displaying information to a computer user. An alphanumeric input device 1022, including alphanumeric and other keys, may also be coupled to bus 1011 for communicating information and command selections to processor 1012. An additional user input device is cursor control 1023, such as a mouse, trackball, trackpad, stylus, or cursor direction keys, coupled to bus 1011 for communicating direction information and command selections to processor 1012, and for controlling cursor movement on display 1021.

Another device that may be coupled to bus 1011 is hard copy device 1024, which may be used for printing instructions, data, or other information on a medium such as paper, film, or similar types of media. Furthermore, a sound recording and playback device, such as a speaker and/or microphone may optionally be coupled to bus 1011 for audio interfacing with computer system 1000. Another device that may be coupled to bus 1011 is a wired/wireless communication capability 1025 to communication to a phone or handheld palm device.

Note that any or all of the components of system 1000 and associated hardware may be used in the present invention. However, it can be appreciated that other configurations of the computer system may include some or all of the devices.

Alternatively, the logic to perform the processes as discussed above could be implemented in additional computer and/or machine readable media, such as discrete hardware components as large-scale integrated circuits (LSI's), application-specific integrated circuits (ASIC's), firmware such as electrically erasable programmable read-only memory (EEPROM's); and electrical, optical, acoustical and other forms of propagated signals (e.g., carrier waves, infrared signals, digital signals, etc.); etc.

Although specific embodiments of the invention have been described and illustrated, the invention is not to be limited to the specific forms or arrangements of parts as described and illustrated herein. For instance, it should also be understood that throughout this disclosure, where a process or method is shown or described, the steps of the method may be performed in any order or simultaneously, unless it is clear from the context that one step depends on another being performed first.

In the foregoing specification, the invention has been described with reference to specific exemplary embodiments thereof It will, however, be evident that various modifications and changes may be made thereto without departing from the broader spirit and scope of the invention as set forth in the appended claims. The specification and drawings are, accordingly, to be regarded in an illustrative rather than a restrictive sense.

What is claimed is:

1. A method for managing persistence of information at the level of information element, where each information element is distinguishable, and discretely and separately identifiable, the method comprising:
navigating received information using an API relevant for the information type or information format of the received information;
extracting structure, semantics and metadata information and data from the received information;
dividing the extracted information into information elements;
constructing an information element container for each of the information elements from the extracted information;
embedding each information element, its semantics, metadata and data into a separate generalized information element container;
persisting each information element container in a storage environment;
retrieving information element containers matching a search criteria from the persisted storage environment;
composing an information set from the retrieved information elements using the semantics, metadata and data embedded in each of the retrieved information element containers to construct an information set; and
transforming the information set into the requested information format.

2. The method defined in claim 1 wherein the received information has a pre-defined structure, is semi-structured, or has an evolving structure.

3. The method defined in claim 2 wherein information with pre-defined structure is one selected from a group consisting of business transaction data or enterprise information.

4. The method defined in claim 2 wherein information with pre-defined structure semi-structured information is one selected from a group consisting of a book, novel or newspaper.

5. The method defined in claim 2 wherein information with pre-defined structure information with an evolving structure is one selected from a group consisting of web content, e-mail, spreadsheet, document, blueprint, drawing, graphics, video stream, audio stream, byte stream or financial statement.

6. The method defined in claim 1 wherein each information element container is one or more of stand-alone, independent of the received information and independent of each other.

7. The method defined in claim 1 wherein each information element container carries information indicative of its structure, semantics and metadata for use in recomposition of one or more of itself, its characteristics, its lineage and or its location with respect to
the received information,
other information elements in the received information,
information elements from other information from a source that produced the received information,
information element from other information from a source other than the source of the received information,
information elements from other information having an information format identical to an information format of the received information,
information elements from other information with an information format different from an information format of the received information,
information element from other information of an information type identical to an information type of the received information, or
information element from other information of an information type different from an information type of the received information.

8. The method defined in claim 6 wherein an information element is combined with other information elements having:
a related identity,
similar or related characteristics,
a same or related lineage, or
a same or related location,
to form a composite that
is same as the original information,
a portion of the original information,
embeds multiple other information,
multiple portions of multiple other information, or
a combination of above,
without regard to whether
each of the original information
had a pre-defined structure
was semi-structured
had an evolving structure
the sources of the each of the original information was same or different
the information formats of each of the original information was same or different.

9. The method defined in claim 1 further comprising:
classifying the information element container based on common characteristics; and
embedding generalized information management capability for each information element classification.

10. The method of claim 9 wherein the information element classification is one selected from a group consisting of date, amount, text, text area, rate, quantity, file, entity, and an element of audio, video, photograph, voice, byte stream, drawing, blueprint or graphics.

11. The method of claim 9 wherein the generalized information management on an information element based on its classification, without the semantic knowledge of the information element, is:
a translation such as translating
from one date format to another date format,
amount from one currency to another currency,
text or text area from one language to another,
a rate from one unit of measure (UOM) to another UOM, or
a quantity from one unit of measure (UOM) to another UOM;
a validation such as ensuring the date element is a valid date,
a consistency check such as for an entity information element.

12. The method defined in claim 1 further comprising:
using persistence management to maintain the information element container as a stand-alone entity in a storage environment using a data management language appropriate to the storage environment.

13. The method defined in claim 11 wherein the storage environment is one of a group selected from a relational database, an object database, a file system, a native network storage device, a native disk storage device.

14. The method defined in claim 12 wherein the storage environment is a relational database, and SQL is used for persistence management.

15. The method defined in claim 12 wherein the storage environment is relational database, and the generalized semantic and metadata of the information element container is included in the column definition of the relational database table.

16. The method defined in claim 12 wherein the storage environment is a relational database, and each information element container is stored in a row.

17. The method defined in claim 12 wherein persistence management includes one or more of a group consisting of store, search, delete, and change.

18. An article of manufacture having one or more computer readable storage medium having instructions which, when executed by a system, cause the system to perform a method for managing persistence of information at the level of an information element, where each information element is distinguishable, and discretely and separately identifiable, the method comprising:
navigating received information using an API relevant for the information type or information format of the received information;
extracting structure, semantics and metadata information and data from the received information;
dividing the extracted information into information elements;
constructing an information element container for each of the information elements from the extracted information;
embedding each information element, its semantics, metadata and data into a separate generalized information element container;
persisting each information element container in a storage environment;
retrieving information element containers matching a search criteria from the persisted storage environment;
composing an information set from the retrieved information elements using the semantics, metadata and data embedded in each of the retrieved information element containers to construct an information set; and
transforming the information set into the requested information format.
